(19) United States
(12) Patent Application Publication
(10) Pub. No.: US 2006/0020369 A1
(43) Pub. Date: Jan. 26, 2006

(54) Robot vacuum cleaner

(76) Inventors: Charles E. Taylor, Punta Gorda, FL (US); Andrew J. Parker, Novato, CA (US); Shek Fai Lau, Foster City, CA (US); Eric C. Blair, San Rafael, CA (US); Andrew Heninger, Stanford, CA (US); Eric Ng, San Leandro, CA (US); Enrico DiBernardo, Glendora, CA (US); Robert D. Witman, Pasadena, CA (US); Michael S. Stout, Rancho Palos Verdes, CA (US)

Correspondence Address: BELL, BOYD & LLOYD LLC, P.O. BOX 1135, CHICAGO, IL, 60690-1135, US

(21) Appl. No.: 11/171,031

(22) Filed: Jun. 30, 2005

Related U.S. Application Data
(63) Continuation-in-part of application No. 10/798,232, filed on Mar. 11, 2004.
(60) Provisional application No. 60/584,090, filed on Jun. 30, 2004.

(51) Int. Cl. G06F 19/00

(52) U.S. Cl. 700/245; 318/568.12

(57) ABSTRACT

The invention covers a robot cleaner that includes a cleaning unit and wheels to move the robot cleaner. The robot cleaner also includes a processor for controlling cleaning that is capable of estimating the size of a room based on distances between obstacles. The robot cleaner has several modes of operation that allow it to clean an entire room more effectively.

### FIELD OF THE INVENTION

The present invention relates generally to robotic cleaners.

### BACKGROUND

Robot cleaners, such as robot vacuums, have been proposed to clean rooms. One robot vacuum is the Roomba™ vacuum from iRobot. The Roomba™ vacuum makes multiple passes through a room in a random fashion. The Roomba™ vacuum starts in a spiral pattern until it contacts a wall, follows the wall for a period of time and then crisscrosses the room in straight lines. After it covers the room multiple times, the Roomba™ stops and turns itself off.

### BRIEF DESCRIPTION OF THE DRAWINGS

FIG. 1A is a diagram that illustrates a functional view of a robot cleaner of one embodiment.

FIG. 1B is a diagram that illustrates a top view of a robot cleaner of one embodiment.

FIG. 1C is a diagram that illustrates a bottom view of a robot cleaner of one embodiment.

FIG. 1D is a diagram that illustrates a side view of a robot cleaner of one embodiment.

FIG. 1E is a diagram that illustrates a remote control of one embodiment of the present invention.

FIG. 2 is a diagram illustrating software modules of one embodiment of the present invention.

FIGS. 3A-3E are diagrams that illustrate a star clean of embodiments of the present invention.

FIG. 3F is a diagram that illustrates a fan clean of one embodiment of the present invention.

FIG. 4 is a diagram that illustrates a “move to new region” mode of one embodiment of the present invention.

FIG. 5 is a diagram that illustrates a robot cleaner using a short term memory map.

FIG. 6 is a diagram that illustrates an wall cleaning mode of an embodiment of the present invention.

FIG. 7 is a diagram that illustrates an entanglement recovery mode of one embodiment of the present invention.

FIGS. 8A and 8B are diagrams that illustrate the operation of an entanglement sensor of one embodiment of the present invention.

FIGS. 9A-9B illustrate direction control embodiments of the robot cleaner.

FIG. 10 illustrate the positioning of a brush of a robot cleaner of one embodiment.

FIG. 11 is a diagram illustrating a V-shaped clean of one embodiment of the present invention.

FIG. 12 is a diagram illustrating operating modes of one embodiment of the present invention.

FIGS. 13A-13B are diagrams illustrating the operation of a bumper sensor of one embodiment of the present invention.

FIG. 14 is a diagram that illustrates the operation of a robot cleaner with barrier cones.

### DETAILED DESCRIPTION

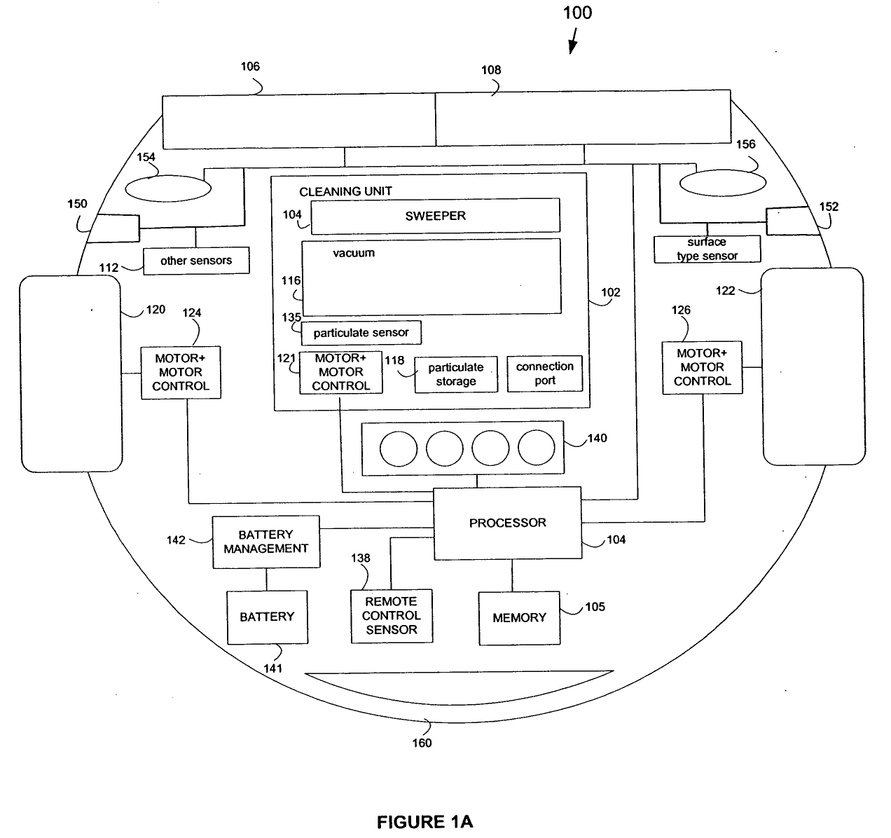

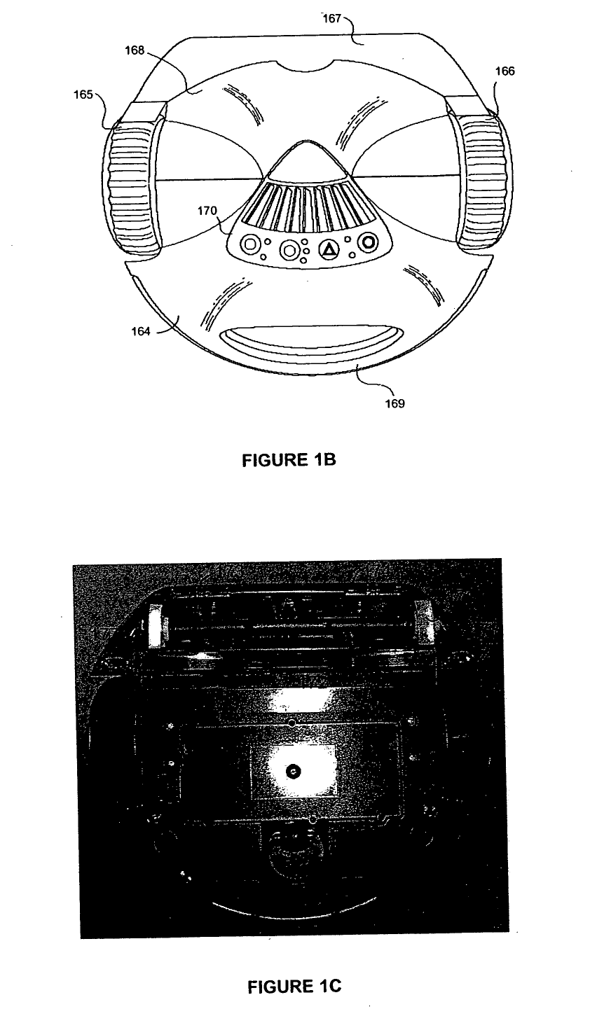

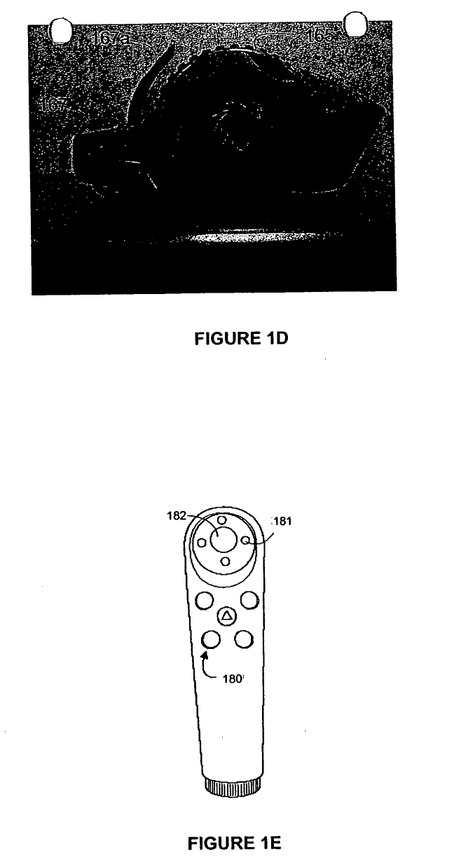

FIG. 1 is a functional diagram of a robot cleaner 100 of an exemplary embodiment of the present invention. In this example, the robot cleaner 100 includes a cleaning unit 102. The cleaning unit 102 can be of a type to clean any object including a cleaning unit to clean carpeted or uncarpeted floors. One cleaning unit comprises a vacuum, with or without a sweeping brush. Alternately, the cleaning unit can comprise a sweeper, duster, cleaning pad or any other type of cleaning unit.

The robot cleaner 100 can include a processor 104 for receiving information from sensors and producing control commands for the robot cleaner 100. For the purposes of this application, the term “processor” includes one or more processor. Any type of processor can be used. The processor 104 can be associated with a memory 105 which can store program code, internal maps and other state data for the robot cleaner 100. The processor 104, in one embodiment, is mounted to a circuit board that connects the processor 104 to wires for the sensors, power and motor controllers. The processor 104 can use software code to implement the modes and behaviors described below.

In the example of FIG. 1, sensors for the robot cleaner 100 include front bumper sensors 106 and 108. In one embodiment, the front sensors use an optical emitter and detector rather than a mechanical switch. The use of more than one front bumper sensor allows the robot cleaner 100 to differentiate between different types of obstacles that the robot encounters. For example, the triggering of a single front sensor may indicate that the robot cleaner 100 has run into a small obstacle. When both front sensors indicate an obstacle, the robot cleaner 100 may have run into a wall or other large obstacle. In one embodiment, the robot cleaner 100 may begin a new operating mode, such as an object following mode, after contacting the wall.

In one embodiment, the cleaning unit 102 includes a sweeping brush 114 that sweeps up dirt and other particulate off of a carpeted or uncarpeted floor. The vacuum 116 can use a fan to draw up dirt and other particulate up to particulate storage 118. The cleaning unit 102 can also include a motor or motors 120 for the sweeper 114 and for the fan used with the vacuum 116.

Other sensors 112 can also be used for obstacle detection. These other sensors 112 can include ultrasonic sensors, infrared (IR) sensors, laser ranging sensors and/or camera-based sensors. The other sensors can be used instead of, or as a complement to, the front bumper sensors.

In one embodiment, sensors are used to detect the position of the robot cleaner. In the example of FIG. 1, sensors associated with wheels 120 and 122 can be used to determine the position of the robot. The wheel sensors can track the turning of the wheels. Each unit of revolution corresponds to a linear distance that the treads of wheels 120 and 122 have traveled. This information can be used to determine the location and orientation of the robot cleaner. In an alternate embodiment, separate encoder wheels can be used.

In one embodiment, optical quadrature encoders can be used to track the position and rotation of the wheels 120 and 122 and thus give information related to the position of the robot cleaner 100.

In one embodiment, a particulate sensor 135 is used to detect the level of particulate cleaned or encountered by the robot cleaner 100. The operation of the robot cleaner 100 can be modified in response to a detected level of particulate. For example, in response to a high detected level of particulate, the robot cleaner can more thoroughly clean the current location. For example, the robot cleaner can slow down, back up or cause more overlap with previously cleaned regions or do a localized clean. When a low level of particulate is sensed, the current location may be cleaned less thoroughly. For example, the robot can be sped up or the overlap reduced.

In one example, the particulate sensor can be optical detector, such as photoelectric detector or a nephelometer, which detects the scattering of light off of particulate. In a photoelectric detector, such as those used in some smoke detectors, the light source and light sensor are positioned at 90-degree angles to one another. The light sensor may also be positioned in a chamber to reduce the ambient light. The detected level of scattered light is roughly proportional to the amount of particulate.

Alternately, a sound or vibration detector can sense the level of particulate cleaned by the robot cleaner. In one example, dirt contacts the sides of the vacuum as it is being acquired. More dirt causes greater noise and vibrations.

In one embodiment, a remote control unit is used. Signals from the remote control (not shown) received by remote control sensor 138 are decoded by processor 104 and used to control the operation of the robot cleaner 100.

The remote control can provide an indication concerning a room state to the robot cleaner. In an automatic cleaning mode, the processor can be used to direct the robot cleaner to clean the room. The processor uses the indication to set a cleaning pattern for the automatic cleaning mode. The room state indication can be an indication of cleaning time, on/off state, hard/soft surface clean, room size, room dirtiness or other indications. In one example, the cleaning time can be selected from the values: 15 minutes, 30 minutes and max life. The hard/soft surface clean indicates whether the surface is carpeted or uncarpeted, for example a hard surface clean can use a reduced speed sweeper operation. In one embodiment, a clean/dirty indication is used to set an overlap in the cleaning pattern. For example, it may be useful to have more overlap for a dirty room.

In one example, the remote control is used to select between an automatic control mode and a user control mode. In the automatic control mode, the processor of the robot directs the robot cleaner while the robot cleaner cleans. In the user control mode, commands from the remote control are used to direct the robot cleaner. The robot cleaner can keep track of its position so that when the robot cleaner returns to the automatic control mode the robot cleaner is able to resume cleaning.

In the example of FIG. 1, the robot cleaner 100 includes a battery 141 which is used to power the operation of the cleaning unit 110, the motors 124 and 126, the processor 104 and any other element that requires power. Battery management unit 142 under control of the processor 104 controls the supply of power to the elements of the robot cleaner 100. In one embodiment, the robot cleaner 100 can be put into a reduced power mode. In one example, the reduced power mode involves turning all or parts of the cleaning unit 102 off. For example, the vacuum and/or the sweeper can be turned off in the reduced power mode. Alternately, the cleaning unit can be put into a mode that uses less power. The processor 104 can automatically put the robot cleaner in a reduced power mode when the processor 104 determines that the robot cleaner 104 is in a region that has been cleaned.

In one embodiment, the robot cleaner 100 has a user input element 140 on its case. The user input element 140 allows for the user to input the size of the room, room clutter, the dirt level, or other indications concerning the room. As discussed above, the size of the room can affect the operation of the robot cleaner.

In one embodiment, additional positioning sensors (not shown) are used as an alternate or supplement to the wheel encoders for determining the position of the robot cleaner 100. These additional positioning sensors can include gyroscopes, compasses and global positioning system (GPS) based units.

The object following sensors 150 and 152 of FIG. 1 can be sonar, infrared or another type of sensor. Object following can use a sensor, such as a Sonar or IR sensor to follow along the side of an object. The signal from the sensor will typically be smaller the further the robot cleaner is from the object. The sensor signal can be used as feedback in a control algorithm to ensure that the robot cleaner keeps a fixed distance from the wall. In one embodiment, the object following sensors are on multiple sides of the robot cleaner. Sensors in the front of the robot cleaner can be used to avoid collisions. Sensors of the side of the robot cleaner can be used to produce a feedback signal while the robot cleaner is moving parallel to the object.

FIG. 1B illustrates an illustration of a top view of a robot cleaner of one embodiment. Shown in this embodiment are the housing 164, wheels 165 and 166, front bumper 167 which contains the bumper sensors, removable particulate section 168, a handle 169, and input buttons 170 with indicator lights. The particulate section 168 can be removable so that the particulate can be thrown away without requiring vacuum bags. The housing 164 can be made of plastic or some other material.

FIG. 1C illustrates the bottom of an exemplary robot cleaner. Shown in this view is sweeper 171, vacuum inlet 172, battery compartment 175, bottom roller 176, bumper sensors 173 and 174, and edge detection sensors 176 and 178.

FIG. 1D illustrates a side view of a robot cleaner. This side view shows an embodiment where the bumper 167 includes an extension 167a to protect the wheel 165 from becoming entangled and to allow for obstacles above the main bumper portion to be detected by the robot cleaner.

FIG. 1E illustrates an exemplary remote control including a number of control buttons 180, a remote control joystick 181 and stop button 182 for remotely steering the robot cleaner. In one embodiment, the signals from the remote control are sent to the robot cleaner to provide state information that the robot cleaner can use during its operations.

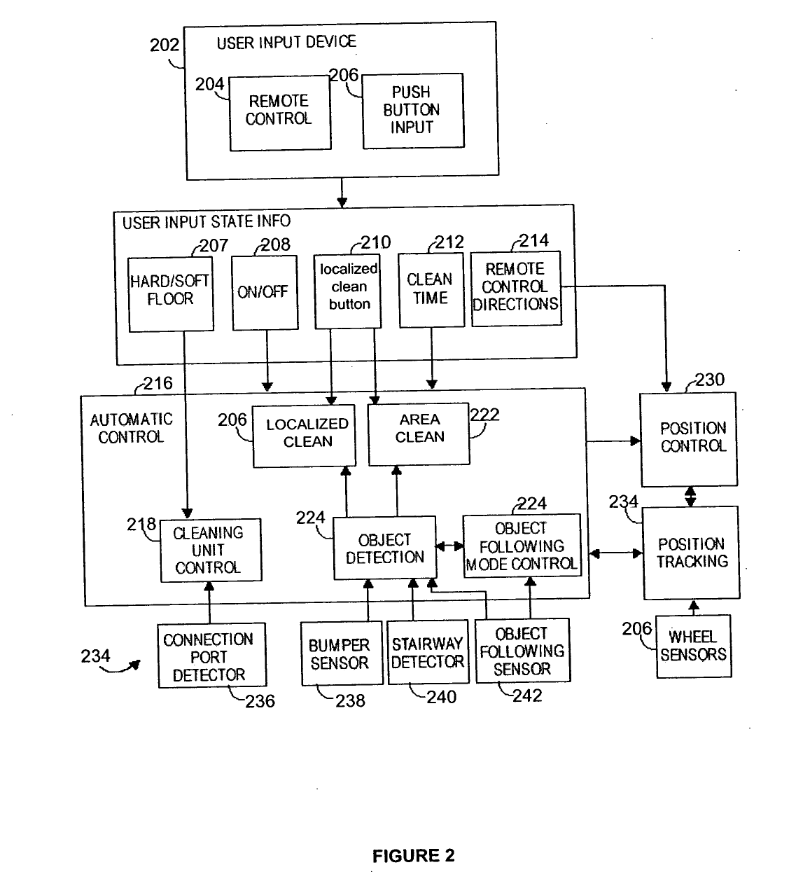

FIG. 2 illustrates control operations of one embodiment the robot cleaner. A user input device 202 such as remote control 204 or push button input 206 on the top of the robot cleaner can be used to provide user state information 204. The user state information 204 can be stored along with other memory used by the robot cleaner, such as mapping information. In this example, the state information includes a hard/soft floor indication 206, an on/off indication 208, a localized clean room indication 210, a cleaning time indication 212 and remote control directions indication, 214. The hard/soft floor indication 206 can be used by cleaning unit control 218 to adjust the operation of sweep floor hard or soft floor. The cleaning unit control controls the operation of the sweeper and the vacuum. In one example, for a hard floor, the sweeper can be turned off or can be caused to revolve slower. The on/off indication 208 can be used to turn on or off the robot cleaner. Additionally, the on/off indication 208 can be used to pause the robot cleaner when the supplemental cleaning elements are used. The localized clean button 210 is used to select between the localized clean control 220 and the area clean control 222. The clean time information 210 is used to select the clean time, such as to select between a 15 minute clean, 30 minute clean or max life clean. The remote control direction indications 214 are provided to the position control 230. The position control 230 can be also controlled by the automatic control unit 216. The position control can also interact with the position tracking unit 232 which can include mapping functions. Position tracking can track the current position of the robot cleaner. In an alternate embodiment, limited or no position tracking is used for some or all of the cleaning functions. In one embodiment, the information for the position tracking unit 232 can be provided by the automatic control 216.

A number of sensors 234 can be used. The bumper detector sensors 238, stairway detector sensors 240 and object following sensor 242 can provide input into the object detection module 224. The object detection module can provide information to the area clean module 322 and localized clean module 220. The object following sensors 242 can also provide a signal to the object following mode control unit 226 for operating the robot cleaner in an object falling mode.

A connection port detector 216 which can be used in one embodiment to detect whether a supplemental cleaning element is attached. In one embodiment, when the detector 216 detects that the supplemental cleaning element is attached, the sweeper can be automatically turned off.

Wheel sensors 244 can also be used to provide information for the position tracking 232. In one embodiment, this information is used for the internal map.

The modules of FIG. 2 can be run on a processor or processors. In one embodiment, conventional operating systems are used due to the speed of a contemporary processors. An alternate embodiment, a real time operating system (RTOS) can be used. Real time operating system are operating systems that guarantees a certain capability within a specified time constraint. Real time operating systems are available from vendors such as Wind River Systems, Inc., of Alameda Calif.

One embodiment of the present invention is a robot cleaner including a cleaning unit 102, wheels to move the robot cleaner and a processor to control the robot cleaner. In a localized cleaning mode, the robot cleaner can repeatedly clean with the cleaning unit through the center of a localized cleaning region at different orientations.

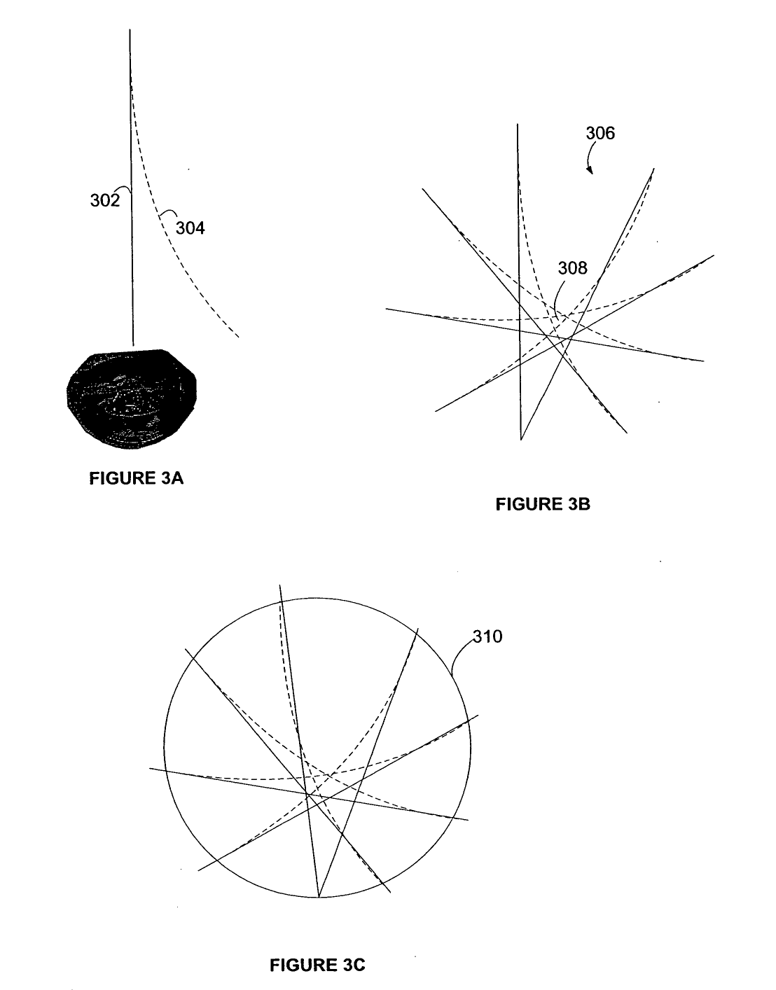

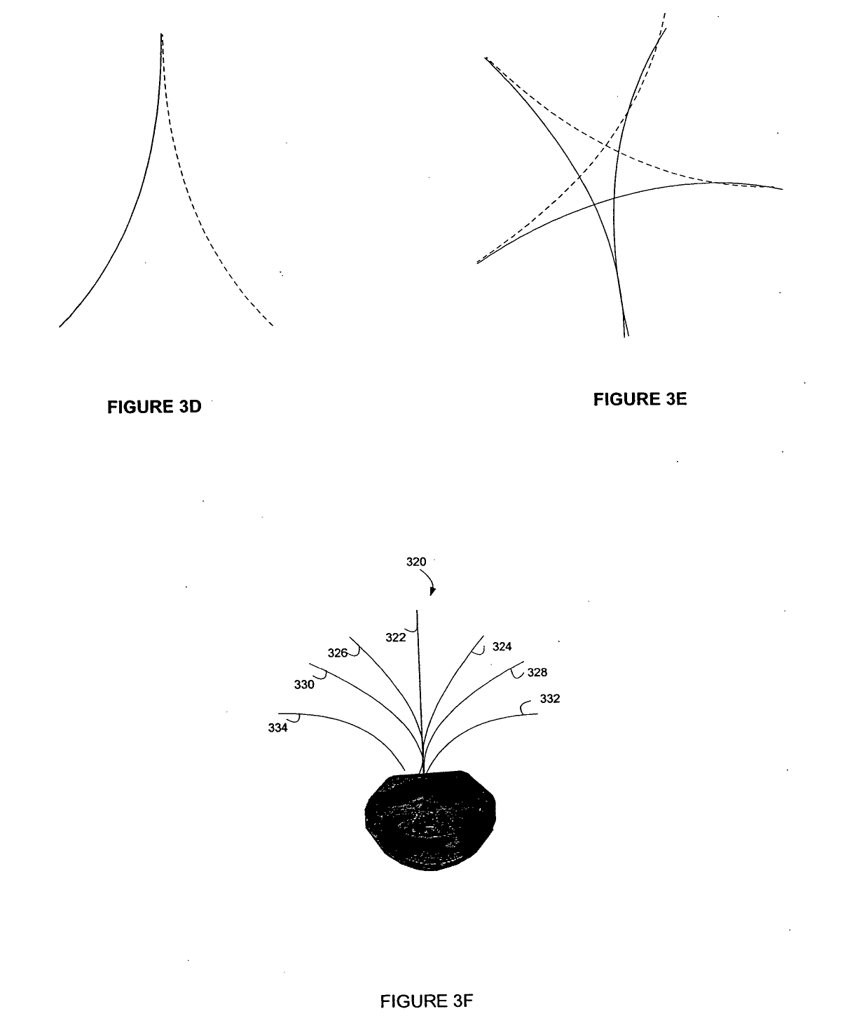

The robot cleaner can do a star-shaped or other type of clean in the localized cleaning region. FIGS. 3A-3E illustrate one example of a star cleaning embodiment. FIG. 3A shows a portion of a star clean with a forward segment 302 and a backward segment 304. In the example of FIG. 3A, the forward segment is straight with a curved backward segment but this need not be the case. FIG. 3B shows an example of a full star pattern 306. In this example, the cleaning repeatedly goes thought the center 308. This can improve the cleaning in the center of the location clean region. The localized clean, such as the star clean, need not require that the robot cleaner end up at the location that the robot cleaner started the localized clean.

The localized clean can focus on a small region for a short period of time using a star pattern. This focus can maximize the number of passes through a central point and minimize the number of gross robot movements. In one embodiment, the robot cleaner does not need to turn around during the star clean procedure. This decreases the time to completion and increases the amount of time that the robot is actually cleaning the required area.

In one embodiment, the robot cleaner moves backward during the star cleaning. When the robot cleaner does not have sensors in the back, the robot cleaner can be controlled to substantially only back over regions that the robot has already occupied. This is especially important if the robot cleaner does not have sensors to detect descending stairways in the back. FIGS. 3D and 3E illustrate an embodiment where the robot cleaner has sensors in the back and can thus move backward into new territory.

The pattern of driving straight and moving backwards along an arc can be repeated until the robot has made a full 360 degree arc. Should the robot contact an obstacle during this time there are several routines which can be initiated depending on the time and location of the bump.

In one embodiment, if the robot detects an obstacle at the very beginning of a first pass and if this obstacle is within the area where the robot is planning to place the center of the spot, the robot will select a ‘fan pattern’ in place of the standard star pattern. This is due to the close proximity of the obstacle and the inability to successfully traverse the standard spot cleaning trajectory. The ‘fan pattern’ can consist of moving back and forth in ever decreasing radii or curvature. This attempts to maximize the coverage of the small available region presented by the user. FIG. 3F illustrates an exemplary fan pattern 320 with passes 322, 324, 326, 328, 330, 332, and 334.

If the robot cleaner detects a bump that is outside the ‘major’ or center portion of the region to be cleaned, the robot cleaner can merely adjusts the center of the spot and continue to clean in the localized clean mode.

At the end of the localized clean, the robot cleaner can do a perimeter clean 310 shown in FIG. 3C. In one example, the perimeter clean picks up dust that has been pushed to the edge of the localized clean region. If there is a disturbance (bumps, stairs, etc.) that has caused a change in trajectory or if the robot cleaner is on a soft surface, such as carpeted floor, the perimeter clean can be skipped. The perimeter clean may work better and be more necessary for a hard surface and in one embodiment the perimeter clean is only done when the hard floor state is selected.

In one embodiment, a robot cleaner determines an estimate of room size based on distances between obstacle detections. The estimate of room size can be used to determine the distance that the robot cleaner goes in a wall following mode when the robot cleaner attempts to move to a new area.

In one embodiment, the robot cleaner can be in one of two operating modes: (i) cleaning and (ii) move to new area. While in a cleaning mode, the robot cleaner can chose to clean near walls (wall cleaning) mode or it can choose to clean an area away from the walls (area clean mode). The probability of picking area clean vs. wall clean can be function of the estimated room size. The room size estimate can be computed as a function of the running average of a number of the last distances the robot cleaner was able to travel in between bump events. In larger rooms, the probability of area clean can be increased to account for the fact that area grows with the square of the room radius while perimeter only grows linearly.

The probability of picking a cleaning mode rather than a “moving to a new area” mode can be a function of the ratio between area covered while in cleaning mode and the estimated area size (computed using the estimated room size). As the amount of cleaned area approaches the estimated area size, the probability of picking “move to a new area” approaches one. When the “move to new area” mode is picked, the robot cleaner can goes into a wall (object) following mode and continue wall following for a distance related to the estimate room size. In one embodiment, the wall following distance is greater than twice the estimated room radius. In one embodiment, the wall following distance is equal to about four times the estimated room radius.

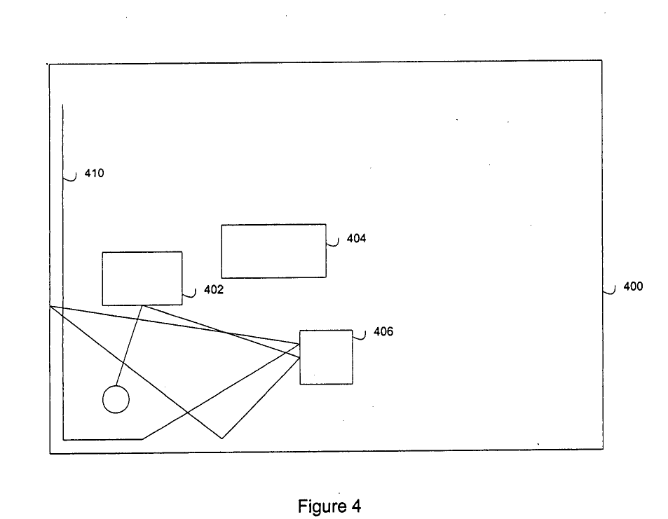

FIG. 4 illustrates an example where the estimated room size is less than the total room size. The robot cleaner determines the estimated room size based on the distance between obstacle detections. Since obstacles 402, 404, and 406 keep the robot cleaner in a small section of the room 400, the estimated room size is based on this small section of the room. The wall following path 410 of the move-to-new-area mode gets the robot cleaner out of this small section of the room.

An indication of an area covered in a cleaning mode can be maintained. The indication of area covered in the cleaning mode and the estimated room size can be used to determine when to move to a new area. The determination of whether to move to a new area can be done when the robot cleaner contacts an obstacle. The determination of whether to move to a new area can be done probabilistically. A predetermined probability curve can be stored as a look-up table in memory. The probability of moving to a new area can depend on the estimated room size and the area covered in a cleaning mode. The robot cleaner can have multiple cleaning modes. The robot cleaner can use the room size estimate to select between cleaning modes, such as between a wall cleaning mode and an area cleaning mode.

In one embodiment, a robot cleaner maintains an internal map, the internal map indicating the orientation of any detected obstacles. The robot cleaner can use the internal map to determine a new direction to go if the robot cleaner detects an obstacle and can clear the internal map after the robot cleaner is out of a local region.

In one embodiment, the robot cleaner employs a short-term memory mechanism to remember the angular location (orientation) of obstacles when it tries to find a straight path it can freely traverse. In one embodiment, the angular location (orientation) of obstacles is maintained with respect to a center location. The first time a bump is detected, the robot cleaner can initialize a linear array of bits, each bit representing a specific direction of motion from a center location and mark the direction the first bump came from as occupied. The robot cleaner can then randomly or systematically pick a new direction among the list of unoccupied directions, rotate to face this new direction and attempt to go forward. If the robot cleaner travels for more than a predetermined distance without bumping into anything, the map can be cleared and the process reinitialized when a new bump occurs. In one embodiment, the predetermined distance is 50 cm. If the robot cleaner bumps into an obstacle before it has traveled the predetermined distance, the obstacle location is registered in the array as an occupied direction and a new direction is picked among all un-occupied directions. The new direction can be picked randomly.

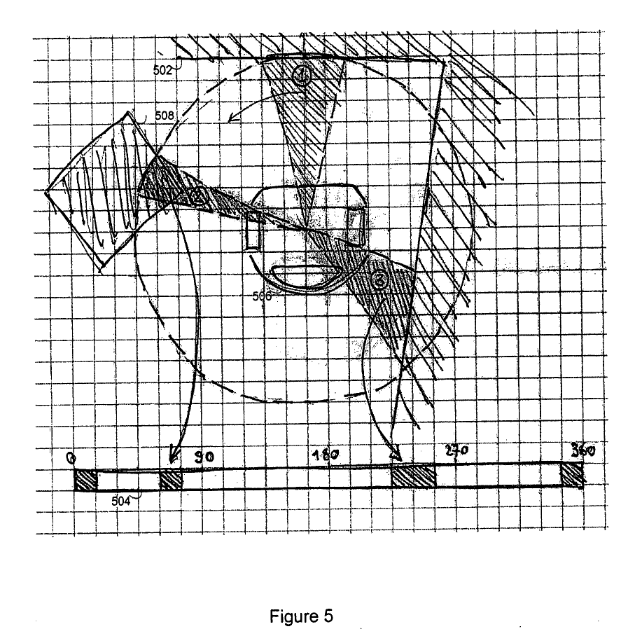

FIG. 5 illustrates an example of this operation. In step 1, an obstacle, the wall 502, is found. The short term map 504 is updated. The robot cleaner 500 moves back to the center and selects a new direction. In step 2, the robot cleaner moves forward and contacts the obstacle 508. The robot cleaner 506 can then move back to the center point and select a new direction. The short term map 504 continues to be updated until the robot cleaner 506 finds a direction from which the robot cleaner 506 can escape.

In one embodiment, the internal map does not store distance information. This means that the internal map is small and easy to work with. For example, the array can be shifted when the robot cleaner turns at the center location. Alternately, a pointer can be stored to indicate the robot cleaner's orientation with respect to the internal map.

The robot cleaner can have a bumper with left and right contact sensors. The triggering of the contact sensors can affect the update of the internal map. In one embodiment, the indicated obstacle in the internal map is greater when both the left and right contact sensors trigger than if only one of the left and right contact sensors trigger. The size of the area indicated for the obstacle in the internal map can also depend on the distance of the obstacle from the center location.

In one embodiment, if the internal map indicates obstacles in a predetermined percentage of directions the robot cleaner goes into an escape mode. For example, if the internal map indicates obstacles in substantially all directions, the robot cleaner can go into the escape mode.

In the escape mode, the robot cleaner can contact-the obstacles, physically probing for an opening so the robot cleaner can escape. The robot cleaner can do short curves after each bump that moves away from then back towards the perimeter of the trapping region. The robot cleaner bumps against the obstacles until it can escape from the local area. This mode can be considered to be a bump wall (obstacle) following mode. In one embodiment, if no escape is found after a predetermined time, the robot cleaner signals that it needs assistance.

In one embodiment, a robot cleaner cleans a first floor region next to a wall such that the bumper of the robot cleaner contacts the wall. The robot cleaner can back up, then clean a second floor region next to the wall with the robot cleaner such that the bumper of the robot cleaner contacts the wall. The second floor region can be adjacent to the first floor region.

In one embodiment, the brush and dust intake of the robot cleaner are located in the front of the unit. This allows the robot cleaner to clean very close to the obstacles that it bumps against. In one embodiment, the brush of the cleaning unit is positioned in front of wheels that move the robot cleaner. The brush of the cleaning unit can be positioned partially or completely inside a region defined by the bumper.

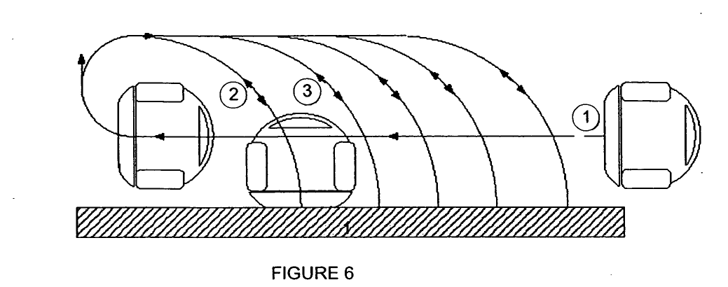

A procedure has been devised that allows the robot cleaner to systematically clean segments near walls or furniture. The procedure is illustrated in the FIG. 6A. During phase (1) the robot cleaner uses wall (object) following behavior to travel at a set distance from the obstacle.

After the robot cleaner has traveled a predetermined distance, such as 1 m, if the edge it has been following was straight, it enters the wall clean procedure. In phase (2) the robot cleaner drives along a curved trajectory while going forward that positions it as parallel as possible to the wall. At this point it enters a “Squaring to wall mode” during which the wheels push the robot cleaner to align the front bumper to the edge of the wall. The robot cleaner can know it has completed the squaring phase when both bumper switches have triggered. The robot cleaner then backs up along the same path it drove forward on until the unit is positioned parallel to the wall. The robot cleaner moves forward for a distance equal to or less than the intake width and repeats the same procedure again. In one embodiment, the distance moved is less than the intake width, for example ⅔ of the intake width, so there is overlap in the wall clean regions. The routine ends when the desired number of passes has been executed or “squaring to wall” procedure has detected the end of the straight segment.

The bumper can have a substantially flat section that is at least one-third, or one-half, as long as the width of the robot cleaner. The wall cleaning can be done for a predetermined distance along a wall. The wall cleaning can be one of multiple cleaning modes. Other cleaning modes can include an area cleaning mode. A serpentine clean can be done in the area cleaning mode. An estimate of the room size can be determined by the robot cleaner. In one embodiment, the robot cleaner is more likely to go into the wall cleaning mode for smaller estimated room sizes. The cleaning modes can be selected probabilistically. The cleaning mode can be selected when an obstacle is contacted. In one embodiment, the backing up of the robot cleaner can stay within an area that the robot cleaner has already moved forward through.

In one embodiment, the robot cleaner detects an entanglement of a brush on the robot cleaner, turns off the brush, moves forward with the brush off, then turns on the brush to detect whether the entanglement is removed.

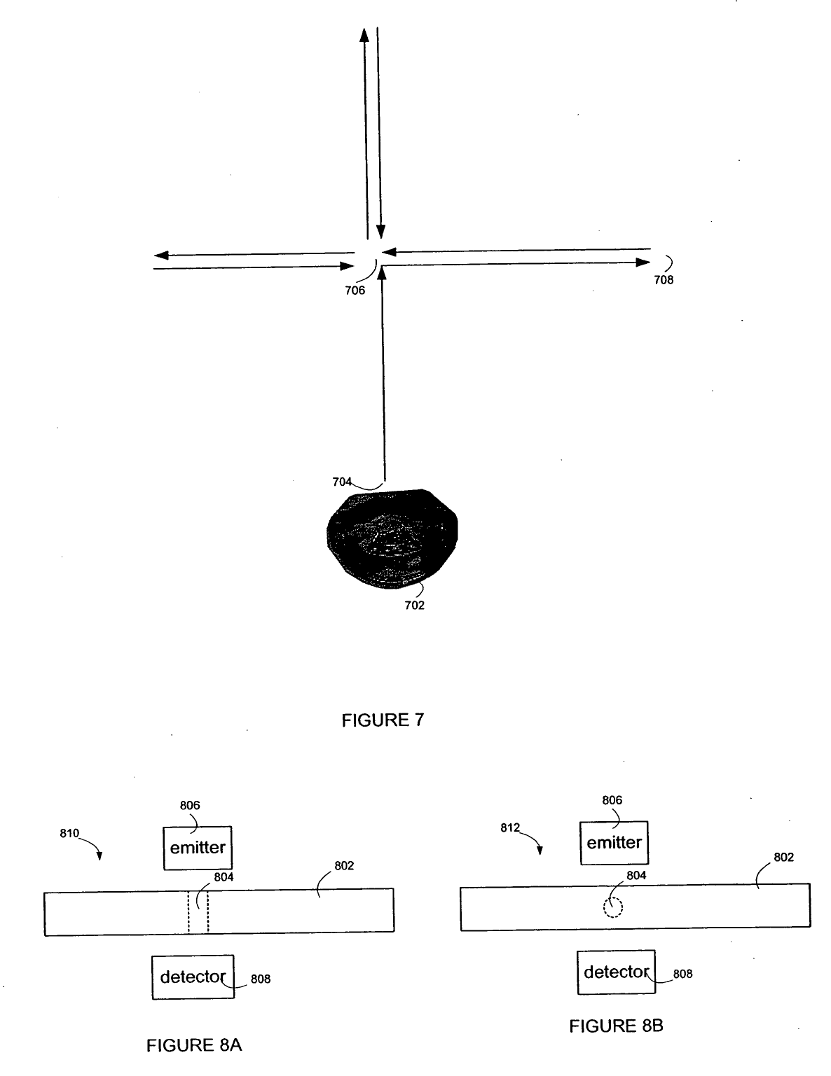

In one embodiment, upon initially detecting that the robot cleaner brush has been entangled, the unit turns off the brush motor. The entanglement can be detected by determining that the brush is not moving by using the system of FIG. 8A and 8B or by using another type of detector. The brush motor can be turned of in the hope that by continuing to move without no power to the brush, the obstruction may be pulled out naturally. The robot cleaner then moves forward. In FIG. 7, the robot cleaner 702 moves from spot 704 to spot 706. After a short time, the brush is tried again. If the brush is still not able to operate, the vacuum fan is turned off, an indicator light is flashed, and the main brush disentangle procedure is entered.

In the main procedure (cycle of steps), the robot cleaner turns 90 degrees, and moves forward a predetermined distance, such as 50 cm. In FIG. 7, the robot cleaner 702 moves from spot 706 to spot 708. This is done to remove the robot cleaner from the previous area in the hope that the obstruction has been partially pulled out and a change in trajectory will aid this removal. At the end of this move, the robot cleaner rotates the brush in the opposite direction then moves backward over its path. This is done to manually try to push the obstruction out of the brush. The brush is then pulsed in a forward direction. If the brush is still not functional after repeating the cycle of steps a number of time, such as eight times, the robot cleaner gives up.

In one embodiment shown in FIGS. 8A and 8B, the brush has a central rod 802 including a hole 804. An emitter 806 and detector 808 are arranged such that in one orientation 810 of the rod 802, light from the emitter passes through the hole 804 to the detector. The emitter 806 and detector 808 can be used to determine if the brush is entangled.

In orientation 810, a signal from emitter 806 is detected by detector 808. In orientation 812, a signal from emitter 806 is not detected by detector 808. The signal at the detector 808 can be used to determine whether the brush is operating normally or is stuck.

In one embodiment, the robot cleaner 100 is able to detect an entangled condition, The processor can monitor the robot cleaner to detect the entangled condition and then adjust the operation of the robot cleaner to remove the entangled condition. Robot cleaners can become entangled at the sweeper or drive wheels 120 and 122. The entangled condition may be caused by a rug, string or other objects in a room. In the example of FIG. 1, motor 120 drives the sweeper 114 and motors 124 and 126 drive the wheels 120 and 122. In one embodiment, when an entangled condition is sensed, the processor adjusts the operation of the robot cleaner to remove the entangled condition.

In an alternate embodiment, the back EMF at a motor can be used to detect an entanglement. The motors driving the wheels and sweeper will tend to draw a larger amount or spike in the current when the motor shaft is stalled or stopped. A back electromotive force (EMF) is created when the motor is turned by an applied voltage. The back EMF reduces the voltage seen by the motor and thus reduces the current drawn. When a rise or spike in the current is sensed at the motor, the stall in the drive wheel, and thus the entanglement condition, can be determined.

The entangled condition can be determined in other ways, as well. In one embodiment, a lack of forward progress of the robot cleaner can be used to detect the entangled condition. For example, when the robot cleaner is being driven forward but the detected position does not change and there are no obstacles detected by the sensors, an entangled condition may be assumed. The detection of the entangled condition can use the position tracking software module described below.

In one embodiment, a robot cleaner system includes a robot cleaner including a cleaning unit and a processor, and a remote control including a directional control. A directional command from the remote control can cause the robot cleaner to shift the cleaning in one direction without requiring a user to hold down the directional control until a spot is reached.

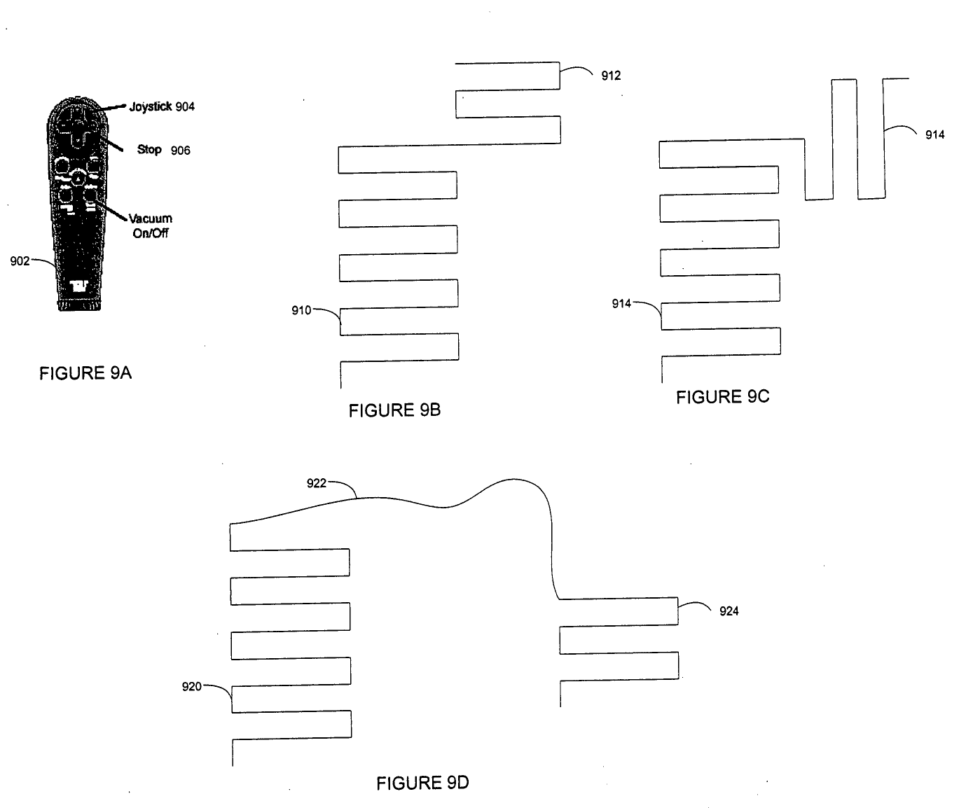

FIG. 9B shows a path of the robot cleaner in an area clean mode in region 910. When the user indicates with the remote control to move to an adjacent region the robot cleaner can shift the area clean to region 912. The shift does not require the user to hold down a directional control until the desired spot is reached. In one embodiment, the robot cleaner stays in the area clean mode. FIG. 9C shows an alternate embodiment where the robot cleaner shifts from cleaning region 914 to cleaning region 916.

FIG. 9A shows a remote control 902 with outer directional control 904 surrounding an inner stop button 906. In one embodiment in an automatic cleaning mode, the processor directs the robot cleaner to clean the room. In a user control mode, a user can direct the robot cleaner using the outer directional control.

In one embodiment, when the robot cleaner is in an area clean mode and the directional command is received, the robot cleaner shifts into cleaning an area in the direction indicated by the direction command. The area clean mode can be a serpentine clean. In one embodiment, if a directional control is pressed for a short period of time, the cleaning shifts into another direction.

In one embodiment, robot cleaner can follow the commands of the directional control for an extended period of time. FIG. 9D shows an example of this type of system. The robot cleaner cleans in an area clean mode in region 920, follows path 922 under the control of the user, and returns into an area clean in region 924. In one embodiment, if directional control is pressed for a longer period of time, the robot cleaner follows the commands of the directional control. Alternately, when the stop button 906 is pressed, the joystick, such as an outer directional controller, is enabled for the remote control of the robot cleaner.

The area clean can be a serpentine clean. In this mode, the robot cleaner cleans a region with cleaning segments up to a predetermined distance. Incremental right (or left) cleaning segments can be done so that the next segment touches or overlaps the last north/south cleaning segment. The width of the cleaning area produced by the cleaning unit of the robot cleaner is related to the level of overlap. The serpentine clean can be done with sharp transitions between horizontal and vertical segments by stopping the robot cleaner at the end of a segment and rotating the robot cleaner to the direction of the next segment. Alternately, the serpentine clean can have curved angles by turning the robot cleaner while the robot cleaner is still moving for a gradual transition from one segment to the next.

The robot cleaner can return to the original location after cleaning the spot or not. In an automatic cleaning mode, a processor can direct the robot cleaner to clean the room. In a user control mode, a user can direct the robot cleaner using an outer directional control. The remote control can include a region with an outer directional control surrounding an inner stop button.

The outer directional control can include four directional projections. The stop button can stop the current mode of the robot cleaner. When the stop button is pressed, the outer directional control can be used for controlling the direction of the robot cleaner.

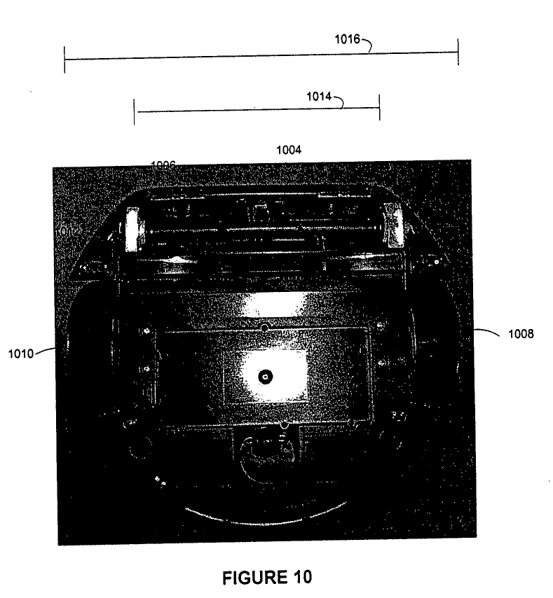

In one embodiment of the present invention as shown in the example of FIG. 10, a robot cleaner 1002 includes a cleaning unit 1004 with a brush 1006 at the bottom of the robot cleaner 1002 and wheels 1008 and 1010 connected to a motor to move the robot cleaner; in wherein the brush 1006 of the cleaning unit is positioned in front of the wheels 1008 and 1010. The robot cleaner can include a bumper 1012. The brush 1006 of the cleaning unit 1004 can be positioned partially, mostly, or completely inside a region defined by the bumper 1012. Having a brush positioned in this location allows for cleaning close to a wall.

In one embodiment, the bumper 1012 has a substantially flat section (length 1014) that is at least one-third, or at least one half as long as the width 1016 of the robot cleaner. Having a bumper with a flat section allows the cleaning unit to be positioned closer to a wall.

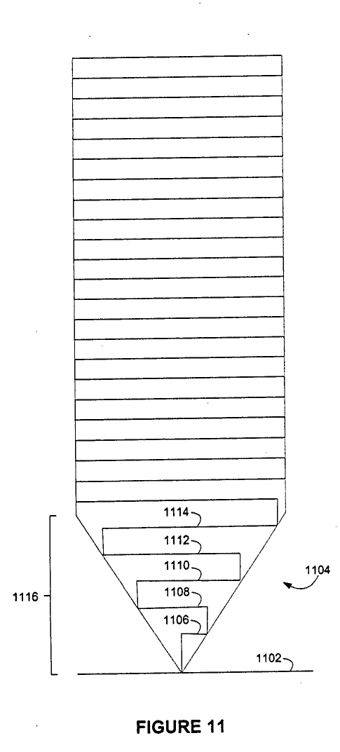

FIG. 11, shows a robot cleaner with an obstacle backaway mode. In one embodiment, the robot cleaner contacts an object, such as wall 1102, and does a serpentine clean 1004 having segments, such as segments 1106, 1108, 1110 and 1112, 1114, that lengthen as the robot cleaner moves away from the object. Such a clean can help avoid other obstacles near the object. This mode can work well along with a wall cleaning mode.

In one embodiment, the cleaned region 1104 includes a V-shaped area 1116. The segments can reach a maximum length after a predetermined distance from the wall. In one embodiment, the serpentine clean is an area clean mode. The robot cleaner has additional cleaning modes, such as a wall cleaning mode and a move-to-new-area mode.

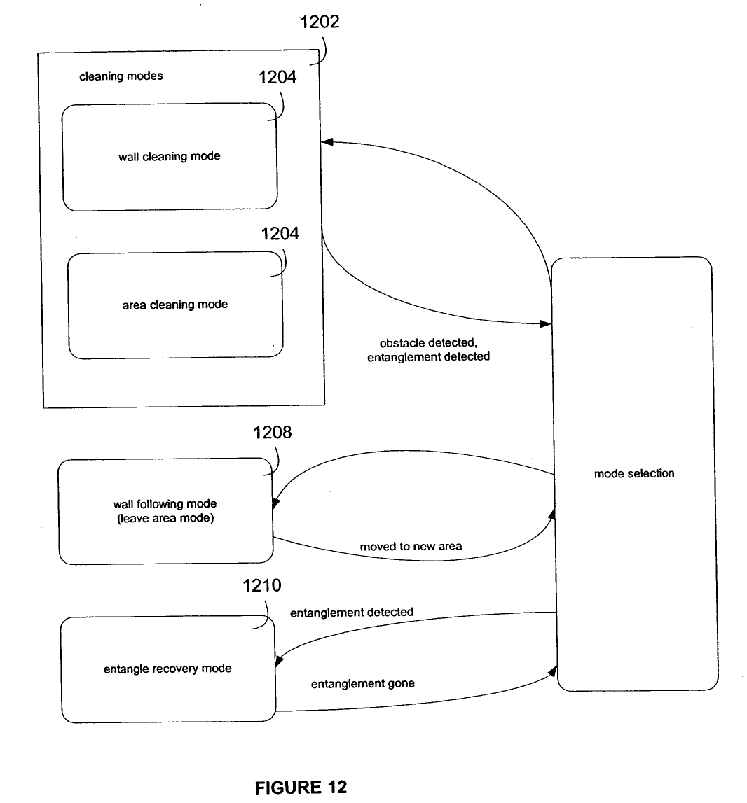

FIG. 12 illustrates an example of some of the modes for the robot cleaner. In this example, the cleaning modes 1202 include a wall cleaning mode 1204 and an area cleaning mode 1206. The wall cleaning mode 1204 can be selected less often for larger rooms. The move-to-new-area mode 1208 can be selected probabilistically based on the estimated room size. The entangle recovery mode 1210 can be entered when an entanglement is detected.

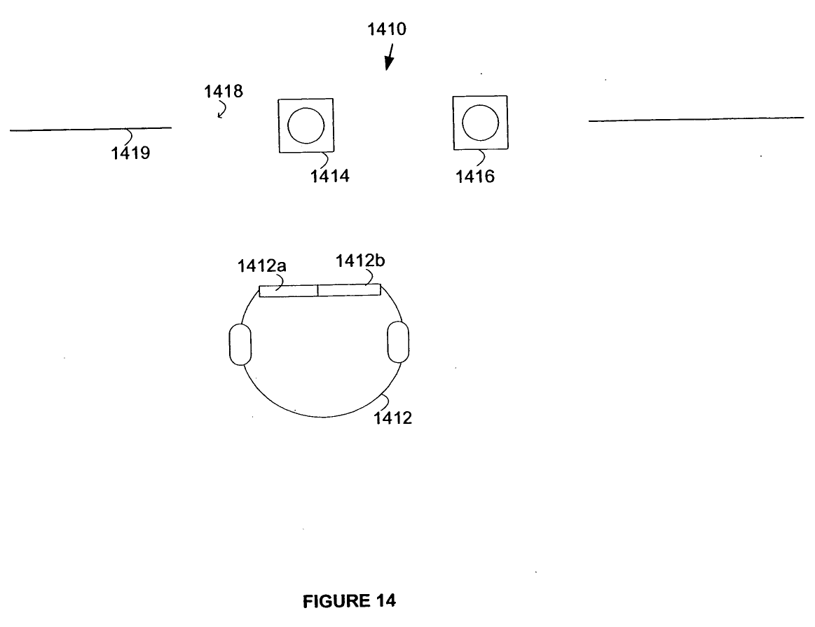

FIG. 14A illustrates a robot cleaning system of one embodiment. The robot cleaning system 1410 can include a robot cleaner 1412 and barrier units 1414 and 1416. The robot cleaner 1412 can include a tactile sensor, such as bumper sensors 1412a and 1412b. The barrier units 1414 and 1416 can be used to prevent the robot cleaner 1412 from passing through a region 1418, such as the doorway defined by wall 1419. When the barrier units are contacted by the robot cleaner 1412, a tactile sensor 1412a and/or 1412b triggers and the robot cleaner redirects itself to avoid the barrier unit. The barrier units can thus be placed to prevent the robot cleaner from leaving a room or falling down stairs. The barrier unit can be such that the tactile sensor on the robot cleaner is triggered by contact with the barrier unit, the triggering of the tactile sensor of the robot cleaner resulting in the robot cleaner changing direction. An anti-slide element and/or weights can be used on the barrier unit to prevent the barrier unit from being moved backwards by the robot cleaner.

The barrier units 1414 and 1416 can be weighted at a bottom portion. In one embodiment, a weight is encased in plastic in the bottom region. The weight lowers the center of gravity of the barrier unit and increases the friction if the barrier unit on the floor surface. The barrier units can also include an anti-slide element to increase the friction with the floor surface. The anti-slide element can include the rubber grommets. In one embodiment, the anti-slide element includes projections on the bottom of the barrier unit. The projections can stick into a carpet surface to help prevent the barrier units from sliding. The projections can be sized such that they are above the lowest part of the barrier unit, such as the rubber grommets, so that the projections would not contact a hard wood floor but can still extend into a carpet. Projections can be put at the bottom of an anti-slide element, such as the rubber grommets. The anti-slide element can include hooks on the bottom of the barrier unit. The hooks can be a strip of the hook portion of a hook and loop fastener, such as Velcro™. These hooks can contact a carpet surface.

The barrier unit can be relatively short. In one embodiment, the barrier unit is less than 6 inches high. In one embodiment, the barrier unit is less than 4 inches high. In one embodiment, the barrier unit is about 3 inches high.

The barrier unit can be a cone. The cone can define a hollow center. This allows the barrier units to be stacked to aid in easy storage and packaging.

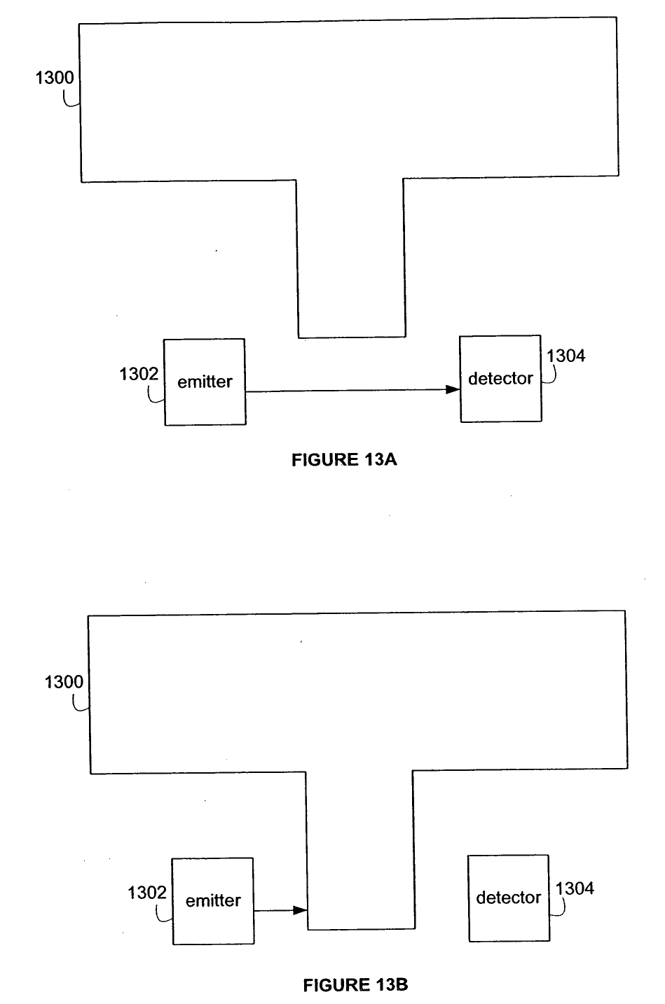

FIGS. 13A and 13B illustrate an example of an optical bump sensor. In FIG. 8A, the element 1300 is biased in a first position where energy from the emitter 1302 reaches the detector 1304. In FIG. 13B, after the bumper contacts an object, the element 1300 is moved to a second position where energy from the emitter 1302 is blocked from reaching the detector 1304. The element 1300 can be a bumper sensor, such as bumper sensors 106 and 108 of the robot cleaner of FIG. 1. The element 1300 can be biased in the first position by a spring (not shown).

A room cleaning mode can be selected by a button on the input 140 of FIG. 1 or by using a remote control. In one embodiment, a particulate detector on the robot cleaner can be used to determine when to switch to a localized cleaning mode. In one embodiment, the processor 104 can be used to control the robot cleaner in the selected cleaning mode.

In one embodiment, a descending stairway can be detected with an edge sensor 154 or 156. The edge sensor unit can include an emitter and a detector. The detector can detect less reflected energy when the sensor is positioned over the descending stairway. The descending stairway is avoided and the cleaning continued.

In one embodiment, a convergent mode sensor can be aimed at the floor. In a convergent mode sensor, only energy reflected from a finite intersection region will be detected. The finite intersection region can be positioned at the floor (focused on the floor). When the convergent mode sensor is over the descending stairway, substantially no reflected energy is detected.

As shown in FIG. 1, the edge sensors 154 and 156 can be positioned at the periphery of the robot cleaner. The edge sensors can be infrared or other types of sensors. In one embodiment, processor 104 can cause the robot cleaner to resume the clean once a descending stairway is avoided.

One embodiment of the present invention includes selecting a floor type mode. The floor type modes including a hard surface mode and a soft surface mode. Operation in the soft surface mode includes rotating a sweeper, such as sweeper 104 of FIG. 1, more than in the hard surface mode. The robot cleaner cleans in the selected floor type mode. The hard surface mode avoids excessive noise that can be associated with a sweeper contacting a wood or other hard surface.

In the hard surface mode, the sweeper can be off or operate at a reduced speed. The soft surface mode can be a carpet cleaning mode. The selection of the floor type mode can be done by pressing a button on the robot cleaner or on a remote control. Alternately, a floor sensor such as a vibration sensor, a mechanical sensor, or an optical sensor, can be used to select between the floor type modes. Processor 104 can be used to control the robot cleaner in the selected floor type mode.

In one embodiment, a supplemental cleaning element can be attached to the robot cleaner. The attachment of the supplemental cleaning element can pause the robot cleaner or the robot cleaner can be paused by pressing a button on the robot cleaner or a remote control. The robot cleaner can be carried and the supplemental cleaning element used to clean to clean an object. In this way, the robot cleaner can be used as a portable vacuum.

The supplemental cleaning element can connect to a connection port on the top or bottom of the robot cleaner. Connecting the supplemental cleaning element to the connection port can result in the normal mode vacuum inlet being mechanically or electromechanically closed. A part of the supplemental cleaning element or connection port can close off the normal mode vacuum inlet. Alternately, the supplemental cleaning element can cover the normal mode vacuum inlet on the bottom of the robot cleaner.

As shown in FIG. 1, the robot cleaner can have a handle, such as handle 160 of FIG. 1, for holding the robot cleaner while cleaning with the supplemental cleaning unit. In the example of FIG. 1, the handle 160 is part of the edge of the robot cleaner.

The supplemental cleaning element can include a hose attachment, a tube, a brush, a nozzle, a crevice tool and other elements. The use of both the robot cleaning mode increases the flexibility and usability of the device.

In one embodiment, indications of cleaned regions can be stored in a long-term internal map. The long-term internal map can be used to determine the cleaned regions for setting the reduced power mode. Power management using the reduced power mode can save battery life.

Using indications of the cleaned regions within a room, such as using a long-term internal map, can also allow the robot cleaner 100 to avoid randomly re-cleaning regions of a room. This also reduces the cleaning time. If the power consumption is kept low using such techniques, an inexpensive battery or a more effective but energy-hungry cleaning unit can be used.

In one embodiment, no internal map is stored. The operations of the cleaning can be done without storing the position information. This can simplify the software and potentially cost of the robot cleaner.

In one embodiment, such as the embodiment shown in FIG. 5, the robot cleaner can store an internal map of less than a full room. In one embodiment, a map of a relatively small area around the robot cleaner is done. The internal map can keep track of objects, such as walls, in the area of the robot cleaner. The position of the robot cleaner can be maintained in the map so that objects can be avoided. In one embodiment, a short time period of data is stored. Old data can be removed from the internal map. Storing the map data for a short period ensures that the data does not become too stale. In one embodiment, data for a period of less than five minutes is stored. In one embodiment, data is stored for about 90 seconds. Alternately, data can be maintained for a specific distance from the robot cleaner. Data for regions outside this distance can be removed. Both of these internal mapping techniques, reduce the memory and processing requirements of the internal mapping.

The robot sensors 112 can include a camera. In one embodiment, the robot vacuum uses computer vision type image recognition. The camera can use a detector which produces a two dimensional array of image information. The camera can be a visible light camera, a thermal camera, an ultraviolet light camera, laser range finder, synthetic aperture radar or any other type of camera. Information from the camera can be processed using an image recognition system. Such a system can include algorithms for filtering out noise, compensating for illumination problems, enhancing images, defining lines, matching lines to models, extracting shapes and building 3D representation.

One example of a camera for use with the Robot Cleaner is a charge coupled-device (CCD) camera to detect visible light. A video camera, such as a camcorder, is arranged so that light falls on an array of metal oxide silicon (MOS) capacitors. Typically, the output of the video signal is an analog signal that is digitized for use by a computer processor. A computer card framegrabber can be used to take analog camera signals and produce a digitized output. Framegrabbers can produce gray scale or color digital images.

An example of a gray scale image uses an 8 bit number to store 256 discreet values of gray. Color can be represented using indications of the color components. For example, by using a red, green, blue (RGB) representation. The cameras can be used to produce orientation information for the robot computer as well as to create a map of the room.

Imaging technology can be used to identify a region in an image with a particular color. On way to do this is to identify all pixels in an image which have a certain color. Pixels which share the same color can be group together. This can be used to identify an object such as a recharge base, which has a specific color.

One use of vision for the robot cleaner can be to determine range information. The range information can be obtained by using two or more cameras. A stereo camera pair can be centered on the same point in an image. The angles of the two cameras can give range information.

In one embodiment, a light striper is used. Light stripers project lines, stripes, grids or a pattern of dots on an environment and then a vision camera observes how a pattern is distorted on an image. Vision algorithms can scan the rows on the image to see whether the projected lines or dot array is continuous. The location of breaks of the line or the array of dots gives information about the size of an obstacle. Relative placement of the lines or array indicate whether the obstacles are above ground or below ground. For example, such a system can be used to determine a descending stairway which should be avoided by the robot cleaner.

In one embodiment, the software used for the robot cleaner can include a software module for vision. The vision software module can interact with other modules such as those for optical avoidance and behavior. In one embodiment, the robotic vacuum uses navigation functionality such as the ERSP navigation tool available from Evolution Robotics. The ERSP navigation tool controls visual location mapping, path planning, obstacle and cliff avoidance exploration and occupancy grid functionality. The localization and mapping system uses images and other sensors to do visual localization as well as to construct a map that includes landmarks generated by the robot as it explores an environment. The localization and mapping compensates for the changes in lighting moving people and moving objects. The robot uses an existing map of an area or creates a map by determining landmarks in a camera image. When the robot cleaner moves from a known location, the robot cleaner can re-orient itself using the landmarks. Path planning modules can use the map with the landmarks to orient the robot within a path. The landmark map can be used to produce a map of clean or unclean regions within a room. The clean/unclean region map can be separate from or integrated with the landmark map. The robot can use the clean/unclean region map to clean the room.

Any number of sensors can be used with the robot. The sensors can include dead reckoning sensors such as odometry sensors, potentiometers, synchros and resolvers, optical encoders and the like. Doppler or internal navigation sensors can also be used. The robot cleaner can also use internal position error correction.

The sensors can also use tactical and proximity sensors including tactile feelers, tactile bumpers, distributed surface arrays. Proximity sensors such as magnetic proximity sensors, inductive proximity sensors, capacitive proximity sensors, ultrasonic proximity sensors, microwave proximity sensors and optical proximity sensors can also be used.

Sensors can include triangulation ranging sensors such as a stereo disparity sensors and active triangulation units. The sensors can include the time of flight (TOF) sensors such as ultrasonic TOF systems and laser-based TOF sensors. The sensors can include phase-shift measurement and frequency modulation sensors. The sensors can include other ranging techniques such as interferometry range from focus, and return signal intensity sensors. The sensors can also include acoustical energy sensors and electromagnetic energy sensors.

The sensors can include collision avoidance sensors that use navigational control strategies such as reactive control, representational world modeling and combined approach. The sensors can also use navigational re-referencing.

The sensors can include guidepath following sensors such as wire guided and optical stripe sensors. The sensors can include a magnetic compass. The sensors can also include gyroscopes including mechanical gyroscopes and optical gyroscopes. The sensors can include RF position-location systems including ground based and satellite bases systems.

The sensors can include ultrasonic and optical position-location sensors. Sensors can include wall, doorway, and ceiling reference sensors.

The sensors can include acoustical sensors, vibration sensors, ultrasonic presence sensors, optical motion detection, passive infrared motion detection, microwave motion detection, video motion detection, intrusion detection on the move and verification and assessment.

In one example, the robot cleaner uses a sensor that produces multiple indications of the distances to an object. An example of such a sensor is an infrared sensor available from Canesta, Inc. of San Jose, Calif. Details of such infrared sensors are described in the U.S. Pat. No. 6,323,932 and published patent applications US 2002/0140633 A1, US 2002/0063775 A1, US 2003/0076484 A1 each of which are incorporated herein by reference.

In one embodiment of the present invention is a robot that includes a sensor producing multiple indications of distances to the closest object in an associated portion of the environment. The processor receives indications from the sensor, determines a feature in the environment and controls a motion unit of the robot to avoid the feature.

The sensor indications can be produced by measuring a period of time to receive a reflected pulse. Alternately, the indications can be produced by measuring an energy of a reflected pulse up to a cutoff time. A determined feature can be indicated in an internal map of the robot. The determined feature can be a step, an object in a room, or other element. The robot can be a robot cleaner.

In one example, an infrared sensor includes an infrared light source to produce pulses of infrared light, optics to focus reflections from the infrared light pulses from different portions of the environment of the robot to different detectors in a 2D array of detectors. The detectors can produce indications of distances to the closest object in an associated portion of the environment.

The optics can include a single or multiple optical elements. In one embodiment, the optics focus light reflected from different regions of the environment to detectors in a 2D array. The detectors produce indications of the distances to the closest objects in associated portions of the environment. The 2D array can includes pixel detectors and associated detector logic. In one embodiment, the 2D array of detectors is constructed of CMOS technology on a semiconductor substrate. The pixel detectors can be photodiodes. The detector logic can include counters. In one embodiment, a counter for a pixel detector runs until a reflected pulse is received. The counter value thus indicates the time for the pulse to be sent from the IR sensor and reflected back from an object in the environment to the pixel detector. Different portions of environment with different objects will have different pulse transit times.

In one embodiment, each detector produces an indication of the distance to the closest object in the associated portion of the environment. Such indications can be sent from the 2D detector array to a memory such as a Frame Buffer RAM that stores frames of the indications. A frame can contain distance indication data of the pixel detectors for a single pulse. A controller can be used to initiate the operation of the IR pulse source as well as to control the counters in the 2D detector array.

The processor in one embodiment is adapted to receive the indications from the IR sensor. In one embodiment, the indications are stored in the frame buffer Random Access Memory (RAM). The indications are used by the processor to determine a feature in the environment and to control the motion of the unit to avoid the feature. Examples of features include steps, walls and objects such as a chair legs. The advantage of the above described IR sensor with a two-dimensional array of detectors is that a full frame of distance indications can be created. Full frames of distance indications simplify feature detection. The burden on the processor is also reduced. In one embodiment, feature detection software receives frames of indications and uses the frames to detect features. Once the features are determined, the features can be added to an internal environment map with feature mapping software. The motion control software can be used to track the position of the robot. Alternately, other elements can be used for positioning the robot. In one embodiment, the robot uses the indications from the detector to determine how to move the robot so that the robot avoids falling down stairs, and bumping into walls and other objects.

In one embodiment, the robot cleaner shuts down when the vacuum becomes tangled in its own cord. Sensors can be located at the sweeper, wheels or cord payout. When the sensor detects an entanglement, signals can be sent to the processor to cause the robot cleaner to shut down.

The robot cleaners can be powered by batteries or power cords. When a power cord is used, the cord can be connected to a wall socket or a unit, such as a central unit connected to a wall socket. The robot cleaner can maneuver to avoid the power cord. A payout can be used to keep the power cord tight. In one embodiment, the robot cleaner keeps the cord on one or the other side of the robot cleaner.

In one embodiment, a robot system includes a robot cleaner including a cleaning unit, and a motion unit, and a unit connected to the robot cleaner by an electrical cord to provide power to the robot cleaner. The robot cleaner can clean the room while connected to the unit and the power cord is wound in as the robot cleaner gets closer to the unit. The unit can be a central unit, wherein the robot cleaner moves around the central unit to clean the room. The unit can be connected to a power socket by another power cord. A payout can be located at the robot cleaner or the unit. The robot cleaner can prevent the power cord from completely wrapping around an object on the floor. The robot cleaner can keep track of its motion to determine motion changes caused by the power cord contacting objects on the floor. The robot cleaner can clean back and forth in region behind the object.

A number of different types of batteries can be used. The batteries can include lithium ion (Li-ion), NiMH, NiCd batteries, and fuel cell batteries. Fuel cell batteries extract energy from hydrogen. When the hydrogen is joined to oxygen forming water energy, is produced. The energy takes the form of electricity and some waste heat. The hydrogen can be obtained from a compound, such as methanol. Fuel cell batteries can provide relatively high energy supply which will be used for powering the vacuum fans and the like on a robot vacuum.

One embodiment of the present invention is a robot cleaner that includes a germicidal ultraviolet lamp. The germicidal ultraviolet lamp can emit radiation when it is energized.

In one embodiment, the cleaning unit includes an electrostatic filter. The germicidal ultraviolet lamp can be positioned to irradiate an airflow before the electrostatic filter. A mechanical filter can also be used. The mechanical filter can be a vacuum cleaner bag. In one embodiment, the robot cleaner is configured to preclude human viewing of UV light emitted directly from the germicidal ultraviolet lamp. When the germicidal ultraviolet lamp is directed towards the floor, the lamp can be placed in a recessed cavity so that the lamp light does not leak out the side of the robot cleaner, but goes directly towards the floor surface. A protective covering for the lamp can be used in this embodiment to prevent the lamp from contacting a thick rug or other raised surface.

The vacuum of this example includes an inlet (not shown). A fan (not shown) can be placed before or after the mechanical filter. In one embodiment, the mechanical filter is a vacuum cleaner bag, which provides for particulate storage. The vacuum cleaner can also includes an electrostatic filter (electrostatic precipitator) to filter additional particulate from an airflow. The airflow goes out the outlet (not shown). In one embodiment, the electrostatic filter includes an emitter which creates ions and a collector which attracts particulate matter.

The foregoing description of the preferred embodiments of the present invention has been provided for the purposes of illustration and description. It is not intended to be exhaustive or to limit the invention to the precise forms disclosed. Many modifications and variations will be apparent to practitioners skilled in the art. The embodiments were chosen and described in order to best explain the principles of the invention and its practical application, thereby enabling others skilled in the art to understand the invention for various embodiments and with the various modifications as are suited to the particular use contemplated. It is intended that the scope of the invention be defined by the following claims and their equivalents.

The invention is claimed as follows:

1. A robot cleaner including:
a cleaning unit;
wheels to move the robot cleaner; and
a processor to control the robot cleaner, wherein an estimate of room size is determined based on distances between obstacle detections, and the estimate of room size is used to determine the distance that the robot cleaner goes in a wall following mode when the robot cleaner attempts to move to a new area.

2. The robot cleaner of claim 1, wherein an indication of area covered in a cleaning mode is maintained.

3. The robot cleaner of claim 1, wherein the indication of area covered in the cleaning mode and the estimated room size are used to determine when to move to a new area.

4. The robot cleaner of claim 1, wherein the determination of whether to move to a new area is done when the robot cleaner contacts an obstacle.

5. The robot cleaner of claim 1, wherein the determination of whether to move to a new area is done probabilistically.

6. The robot cleaner of claim 1, wherein the determination of whether to move to a new area is done probabilistically and the probability of moving to a new area depends on the estimated room size.

7. The robot cleaner of claim 1, wherein the determination of whether to move to a new area is done probabilistically and the probability of moving to a new area depends on the area covered in a cleaning mode.

8. The robot cleaner of claim 1, wherein the robot cleaner has multiple cleaning modes.

9. The robot cleaner of claim 1, wherein the robot cleaner uses the room size estimate to select between cleaning modes.

10. The robot cleaner of claim 1, estimate to select between a wall cleaning mode and an area cleaning mode.

11. A robot cleaner including:
a cleaning unit; and
a processor to control the robot cleaner, wherein an internal map is maintained, the internal map indicating the orientation of any detected obstacles, the internal map is used to determine a new direction to go if the robot cleaner detects an obstacle, the internal map is cleared after the robot cleaner is out of a local region.

12. The robot cleaner of claim 11, wherein the internal map is cleared after traveling a predetermined distance without encountering another obstacle

13. The robot cleaner of claim 11, wherein the robot cleaner moves to a center location after encountering an obstacle.

14. The robot cleaner of claim 11, wherein the robot cleaner moves to a center location after encountering an obstacle and the robot cleaner moves in a direction indicated by the internal map as being potentially unoccupied after moving to the center location.

15. The robot cleaner of claim 11, wherein the internal map is stored as an array.

16. The robot cleaner of claim 11, wherein the internal map is stored as an array and the internal map array is shifted when the robot cleaner turns.

17. The robot cleaner of claim 1 1, wherein the robot cleaner has a bumper with left and right contact sensors, and wherein the triggering of the contact sensors effects the update of the internal map.

18. The robot cleaner of claim 17, wherein if both left and right contact sensors trigger the indicated obstacle in the internal map is greater than if only one of the left and right contact sensors trigger.

19. The robot cleaner of claim 11, wherein if the internal map indicates obstacles in a predetermined percentage of directions the robot cleaner goes into an escape mode.

20. The robot cleaner of claim 19, wherein in the escape mode the robot cleaner does curves that contacts the obstacles until an escape is found.

21. The robot cleaner of claim 20, wherein if no escape is found after a predetermined time the robot cleaner signals that it needs assistance.

22. A robot cleaner including:
a bumper;
a cleaning unit; and
a processor to control the robot cleaner, wherein a first floor region next to a wall is cleaned with the robot cleaner such that the bumper of the robot cleaner contacts the wall, the robot cleaner backs up, and wherein a second floor region next to the wall is cleaned with the robot cleaner such that the bumper of the robot cleaner contacts the wall, the second floor region being adjacent to the first floor region.

23. A robot cleaner including:
a cleaning unit with a brush; and
a processor to control the robot cleaner, wherein an entanglement of the brush is detected, the brush is turned off, the robot cleaner moves forward with the brush off, and the brush is turned on to detect whether the entanglement is removed.

24. A robot cleaner system comprising:
a robot cleaner including a cleaning unit and a processor; and
a remote control including a directional control, wherein a directional command from the remote control causes the robot cleaner to shift the cleaning in one direction without requiring a user to hold down the directional control until a spot is reached.

25. The robot cleaner system of claim 24, wherein if directional control is pressed for a short period of time the cleaning shifts into another direction.

26. The robot cleaner system of claim 24, wherein if directional control is pressed for a short period of time the cleaning shifts into another direction and if directional control is pressed for a longer period of time the robot cleaner follows the commands of the directional control.

27. The robot cleaner system of claim 24, wherein in a user control mode, a user can direct the robot cleaner using an outer directional control.

28. A robot cleaner including:
a housing;
a cleaning unit at the bottom of the housing; and
a bumper on the housing to sense obstacles, wherein after contacting an obstacle with the bumper, the robot cleaner does a serpentine clean having segments that lengthen as the robot cleaner moves away from the object.
